(19) United States
(12) Patent Application Publication
(10) Pub. No.: US 2019/0026730 A1
(43) Pub. Date: Jan. 24, 2019

(54) SYSTEMS AND METHODS FOR DISTRIBUTED LEDGER-BASED PEER-TO-PEER LENDING

(71) Applicant: JPMorgan Chase Bank, N.A., New York, NY (US)

(72) Inventors: Christine Moy, New York, NY (US); Huw L. Richards, New York, NY (US); Tyrone Lobban, London (GB); Samer Falah, Staten Island, NY (US); Christina Finizio, Hong Kong (HK); Amber Baldet, Brooklyn, NY (US)

(21) Appl. No.: 16/040,696

(22) Filed: Jul. 20, 2018

Related U.S. Application Data
(60) Provisional application No. 62/534,772, filed on Jul. 20, 2017.

(51) Int. Cl. G06Q 20/36; G06Q 20/06; G06Q 20/22; G06Q 40/06; G06F 21/64; H04L 9/06

(52) U.S. Cl. CPC G06Q 20/367; G06Q 20/065; H04L 9/0637; G06Q 40/06; G06F 21/64; G06Q 20/223

(57) ABSTRACT

In one embodiment, a method for distributed ledger-based peer-to-peer lending may include: receiving, from a first node in a network associated with one of a debt issuer or an investor, a transaction between the debt issuer and the investor, the transaction comprising a cash portion and a debt portion; generating a debt token for the debt portion; writing the debt token to a wallet for the debt issuer that is tracked on a distributed ledger; generating a cash token for the cash portion; writing the cash token to a wallet for the investor that is tracked on a distributed ledger; settling the transaction by exchanging the cash tokens from the wallet for the investor and the debt tokens from the wallet for the debt issuer; and writing the settled transaction to the distributed ledger.

### RELATED APPLICATIONS

This application claims priority to U.S. Provisional Patent Application Ser. No. 62/534,772, filed Jul. 20, 2017, the disclosure of which is hereby incorporated, by reference, in its entirety.

### BACKGROUND OF THE INVENTION

### 1. Field of the Invention

The present disclosure generally relates to systems and methods for distributed ledger-based peer-to-peer lending.

### 2. Description of the Related Art

Distributed ledgers, such as Blockchain-based distributed ledgers, provide a cryptographically-verifiable, immutable, record for transactions. In view of these and other qualities, distributed ledgers may be used as a system of record for transactions between and among parties.

### SUMMARY OF THE INVENTION

Systems and methods for distributed ledger-based peer-to-peer lending are disclosed. In one embodiment, in an information processing apparatus comprising at least one computer processor, a method for conducting a distributed ledger-based peer to peer transaction may include: (1) receiving, from a first node in a network, the first node associated with one of a debt issuer or an investor, a transaction between the debt issuer and the investor, the transaction comprising a cash portion and a debt portion; (2) generating at least one debt token for the debt portion; (3) writing the at least one debt token to a wallet for the debt issuer that is tracked on a distributed ledger; (4) generating at least one cash token for the cash portion; (5) writing the at least one cash token to a wallet for the investor that is tracked on a distributed ledger; (6) settling the transaction by exchanging the at least one cash tokens from the wallet for the investor and the at least one debt tokens from the wallet for the debt issuer; and (7) writing the settled transaction to the distributed ledger.

In one embodiment, the method may further include a first smart contract verifying that the debt issuer has lending capacity for the debt portion.

In one embodiment, the method may further include a second smart contract verifying that the investor has funds for the cash portion.

In one embodiment, a third smart contract may generate the at least one debt token. In one embodiment, the debt issuer may generate the at least one debt token.

In one embodiment, a fourth smart contract may generate the at least one cash token. In one embodiment, a financial institution may generate the at least one cash token.

In one embodiment, a fifth smart contract may exchange the at least one cash tokens from the wallet for the investor and the at least one debt tokens from the wallet for the debt issuer.

In one embodiment, the step of writing the settled transaction to the distributed ledger may include updating a cash balance in the wallet for the investor; and updating a debt balance in the wallet for the debt issuer.

In one embodiment, the transaction may include a private transaction.

In another embodiment, in an information processing apparatus comprising at least one computer processor, a method for conducting a distributed ledger-based peer to peer transaction may include: (1) receiving, from a first node in a network, the first node associated with one of a debt issuer or an investor, a transaction between the debt issuer and the investor, the transaction comprising a cash portion and a debt portion; (2) generating at least one debt token for the debt portion; (3) writing the at least one debt token to a wallet for the debt issuer that is tracked on a distributed ledger; (4) generating at least one cash token for the cash portion; (5) writing the at least one cash token to a wallet for the investor that is tracked on a distributed ledger; (6) settling the transaction by transferring and destroying the at least one cash token from the wallet for the investor, transferring the at least one debt token from the wallet for the debt issuer to the wallet for the investor, and depositing a cash amount for the at least one cash token to the wallet for the debt issuer.

In one embodiment, the method may further include a first smart contract verifying that the debt issuer has lending capacity for the debt portion.

In one embodiment, the method may further include a second smart contract verifying that the investor has funds for the cash portion.

In one embodiment, a third smart contract may generate the at least one debt token. In one embodiment, the debt issuer may generate the at least one debt token.

In one embodiment, a fourth smart contract may generate the at least one cash token. In one embodiment, a financial institution may generate the at least one cash token.

In one embodiment, a fifth smart contract may transfer and destroy the at least one cash token from the wallet for the investor, transfer the at least one debt token from the wallet for the debt issuer to the wallet for the investor, and deposits the cash amount for the at least one cash token to the wallet for the debt issuer.

In one embodiment, the step of writing the settled transaction to the distributed ledger may include updating a cash balance in the wallet for the investor; and updating a debt balance in the wallet for the debt issuer.

In one embodiment, the transaction may include a private transaction.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for distributed ledger-based peer-to-peer lending according to one embodiment; and

FIG. 2 depicts a method for distributed ledger-based peer-to-peer lending according to one embodiment.

### DETAILED DESCRIPTION OF PREFERRED EMBODIMENTS

The disclosures of the following U.S. patent applications are hereby incorporated by reference in their entireties: U.S. Patent Application Ser. Nos. 62/224,185; 15/797,602; 62/414,398; 15/820,758; 15/869,421; and 62/446,185.

Embodiments disclosed herein relate to systems and methods for distributed ledger-based peer-to-peer lending.

In embodiments, a distributed ledger-based peer-to-peer lending platform may be decentralized in which parties to a transaction (e.g., borrowers and lenders) may pursue price discovery and transact with little or no involvement from an intermediary, such as a financial institution.

In embodiments, smart contracts may separately manage interactions between network participants that are public (e.g., indicative debt offerings, etc.) and interactions that are private (e.g., price discovery, bid amount, loan servicing, etc.).

In embodiments, smart contracts may be used to automate, for example, the payment of the principal for a long-term debt instrument over its life cycle, interest payments, or principal repayment for a short-term discount debt instrument, etc.

Smart contracts may be used to create debt tokens and cash tokens. For example, the tokens may be created natively onto the Blockchain. The cash tokens and debt tokens may be atomically exchanged and may be linked with each other (e.g., if the cash is not moved from the lender to the borrower, the debt instrument cannot be moved by the borrower to the lender; if the cash is not returned from the borrower to the lender, the borrower's debt instrument obligation is not extinguished by the lender; etc.).

Smart contracts may also be used to track the ownership of each of these debt and cash instruments without requiring a central intermediary to keep the books-and-records.

In one embodiment, certain analytics and benchmarking may be used. For example, a smart contract may capture and anonymize marketplace activities and corresponding metadata, such as time, prices, market-wide indices, etc. in order to facilitate a marketplace data and benchmarking service to market participants.

In one embodiment, a smart contract may check with an oracle (e.g., a data feed such as a credit rating stream) that may be incorporated into benchmarking along with the issuance, and may also check portfolio limits. For example, a smart contract may monitor investments, and alert when a limit (e.g., no more than 25% of portfolio in tech companies) is breached.

In one embodiment, smart contracts may be used to manage cash or other assets for an organization. For example, an organization may input its daily cash needs or cash surpluses, and the system may use that data, marketplace, the organization's risk limits, ratings of other issuers and investors, and any other parameters to optimize either the use of cash from the organization's perspective if it has a surplus, or the issuance of debt (e.g., getting the best pricing for the issuer based on what the marketplace will bear).

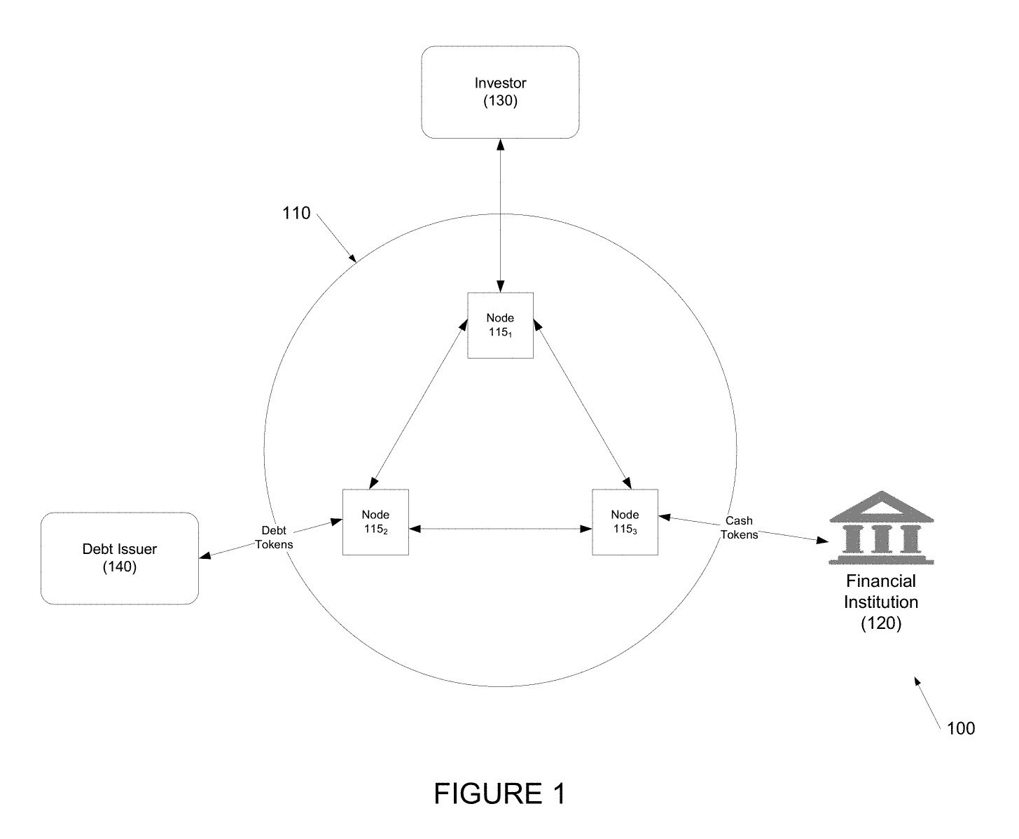

Referring to FIG. 1, a system for distributed ledger-based peer-to-peer lending is disclosed according to one embodiment. System 100 may include network 110 that may include a plurality of nodes 115₁, 115₂, 115₃. In one embodiment, each node 115 may include a distributed ledger, such as a Blockchain-based distributed ledger. In one embodiment, the distributed ledger may hold the debt repository capturing data and a shared ledger representing the new loans and executing contributed by all participants.

Although FIG. 1 depicts three nodes 115, it should be recognized that additional nodes may be provided as is necessary and/or desired.

In one embodiment, financial institution 120 may issue and/or receive cash tokens from network 110. In one embodiment, a cash token may be a legal representation of cash enabled by participating deposit-holding banks. The cash tokens may be represented and/or created by smart contracts which may enable a delivery versus payment, or DVP. In one embodiment, the tokens may be split (e.g., using a Unspent Transaction Output, or UTXO model).

System 100 may further include investor 130 and debt issuer 140. In one embodiment, investor 130 may seek to invest with debt issuer 140 by, for example, purchasing debt from debt issuer 140 for a fee (e.g., interest). In one embodiment, financial institution 120, investor 130, and debt issuer 140 may interact with network 110 using, for example, an assigned node, using an interface (e.g., an application programmable interface, or API, etc.).

It should be recognized that although only one investor 130 and debt issuer 140 are illustrated in FIG. 1, additional investors 130 and/or debt issuers 140 may be included as is necessary and/or desired.

In one embodiment, debt issuer 140 may issue debt tokens. Debt tokens may be a legal representation of a debt instrument issued by debt issuer 140. The debt tokens may be created by dual smart contracts representing the public and private aspects of the marketplace, and a private contractual relationship. The tokens may also be split (e.g., using a UTXO model).

In one embodiment, the debt tokens may be created publicly. Details of the transaction between investor 130 and debt issuer 140 (e.g., bid price, acceptance or rejection of the bid, etc.) may be private and available only to the parties to the transaction.

In one embodiment, the debt tokens may be created to have a constant size, and the ownership of the debt token may not be reflected in the token itself. For example, debt tokens may be created with a fixed value (e.g., dollars or other currency). The ownership of each debt token may be recorded in, for example, a distributed ledger.

In one embodiment, network 110 may be a private network.

In one embodiment, individuals or corporation with access to one of the plurality of nodes 115 (e.g., dedicated node, via a third party (e.g., broker), via an API, etc.) can issue or invest in a primary debt obligation.

Network 110 may interact with a number of other entities and/or data sources, such as regulator(s) and/or administrators (not shown), credit rating agencies (not shown), market data feed (not shown), book building and portfolio management (not shown), Investment Book of Record (IBOR) and payments scheduling (not shown), advisors (not shown), auditors (not shown), custodians (not shown), etc. Each of these entities may be associated with a node 115, or it may access network 110 using an interface, such as an API.

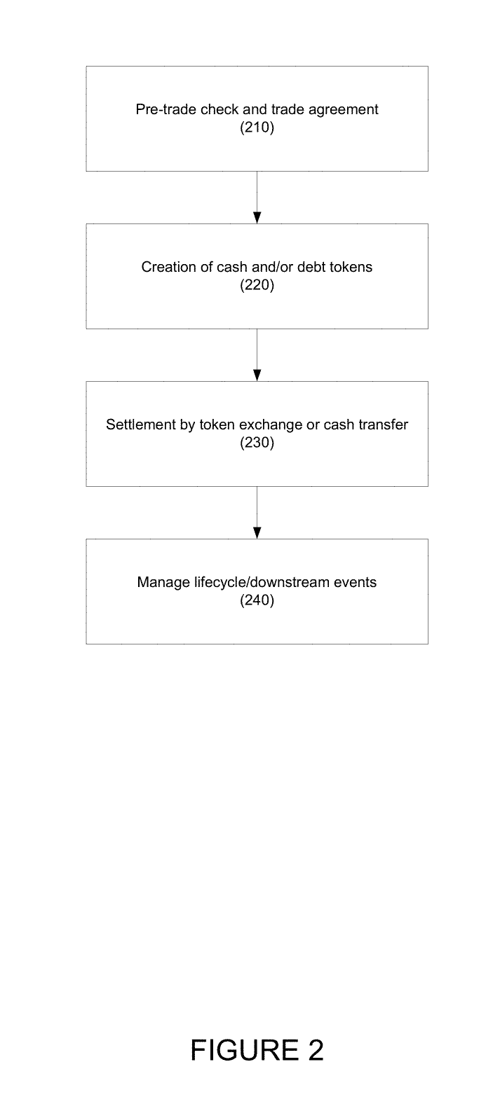

Referring to FIG. 2, a method for distributed ledger-based peer-to-peer lending is disclosed according to one embodiment. In step 210, a pre-trade check may be conducted, and a trade agreement may be established. For example, the two parties to an investment transaction, such as an investor and a debt issuer, may establish the terms for the investment transaction, and smart contract(s) may confirm that each of the parties are capable of entering into the transaction.

For example, if a debt issuer agrees to issue debt to an investor with certain terms, a first smart contract may confirm that the debt issuer has the lending capacity, and a second smart contract may confirm that the investor has the funds available to pay for the debt. Any other suitable checks may be performed as is necessary and/or desired.

In one embodiment, the transaction may be received using, for example, a computer program, an application executed by an electronic device, an Internet of Things (IoT) appliance, etc.

In step 220, one or more token(s) may be created. In one embodiment, one or more tokens may be created for each party to represent the party's part of the transaction. For example, a third smart contract may create debt token(s) for the debt issuer and may send the debt token(s) to the debt issuer's wallet (e.g., a wallet maintained and/or tracked using the distributed ledger wallet). A fourth smart contract may create cash tokens for the investor when the investment amount is withdrawn, escrowed, or encumbered from the investor's bank account. The cash tokens may be moved to the investor's distributed ledger wallet.

In step 230, the transaction may be settled. In one embodiment, the transaction may be settled by exchanging tokens between the parties (e.g., the debt issuer's debt tokens for the investor's cash tokens). For example, a fifth smart contract may be used to exchange debt tokens from the debt issuer's wallet (e.g., debt tokens) to the investor's wallet, and cash tokens from the investor's wallet (e.g., cash tokens) to the debt issuer's wallet. The transaction may be written to the distributed ledger, and the balances in each party's wallet(s) may be updated.

The exchange may be atomic and simultaneous, or nearly simultaneous.

In another embodiment, the transaction may be settled by a cash transfer. For example, a sixth smart contract may be used to transfer cash tokens from the investor to a bank or a third party to be destroyed, transfer the debt tokens to the investor's wallet, and deposit, transfer, or release the debt amount into the debt issuer's wallet or account.

The transaction may be written to the distributed ledger, and the balances in each party's wallet(s) may be updated.

In step 240, lifecycle and/or downstream events may be executed and/or managed. In one embodiment, lifecycle events may be managed by smart contracts. For example, interest may be automatically calculated and paid to investors via on-chain cash tokens or via raising events to off-chain bank wire systems. As another example, smart contracts may be used to automatically process corporate actions, such as the processing of a mandatory conversion of debt.

In another embodiment, at maturity, the debt may be automatically repaid. This may be accomplished using, for example, one or more smart contracts that may automatically transfer funds as cash tokens or wire transfers back to the investor (plus interest at maturity), while simultaneously extinguishing or destroying the corresponding debt tokens.

In another embodiment, debt tokens may be exchanged, peer-to-peer, from an original investor to a new investor in a secondary market. Smart contracts may ensure that a given debt token cannot be sold to more than one investor, and that new debt tokens cannot be created by investors. The onward selling of debt tokens to new investors will preserve the privacy of the transaction between the buyer and the seller and will ensure that the new holder of the debt token receives the same benefits that the original investor received, for example receipt of periodic interest payments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for conducting a distributed ledger-based peer to peer transaction, comprising:
in an information processing apparatus comprising at least one computer processor:
receiving, from a first node in a network, the first node associated with one of a debt issuer or an investor, a transaction between the debt issuer and the investor, the transaction comprising a cash portion and a debt portion;
generating at least one debt token for the debt portion;
writing the at least one debt token to a wallet for the debt issuer that is tracked on a distributed ledger;
generating at least one cash token for the cash portion;
writing the at least one cash token to a wallet for the investor that is tracked on a distributed ledger;
settling the transaction by exchanging the at least one cash tokens from the wallet for the investor and the at least one debt tokens from the wallet for the debt issuer; and
writing the settled transaction to the distributed ledger.

2. The method of claim 1, further comprising:
a first smart contract verifying that the debt issuer has lending capacity for the debt portion.

3. The method of claim 1, further comprising:
a second smart contract verifying that the investor has funds for the cash portion

4. The method of claim 1, wherein a third smart contract generates the at least one debt token.

5. The method of claim 1, wherein the debt issuer generates the at least one debt token.

6. The method of claim 1, wherein a fourth smart contract generates the at least one cash token.

7. The method of claim 1, wherein a financial institution generates the at least one cash token.

8. The method of claim 1, wherein a fifth smart contract exchanges the at least one cash tokens from the wallet for the investor and the at least one debt tokens from the wallet for the debt issuer.

9. The method of claim 1, wherein the step of writing the settled transaction to the distributed ledger comprises:
updating a cash balance in the wallet for the investor; and
updating a debt balance in the wallet for the debt issuer.

10. The method of claim 1, wherein the transaction comprises a private transaction.

11. A method for conducting a distributed ledger-based peer to peer transaction, comprising:
in an information processing apparatus comprising at least one computer processor:
receiving, from a first node in a network, the first node associated with one of a debt issuer or an investor, a transaction between the debt issuer and the investor, the transaction comprising a cash portion and a debt portion;
generating at least one debt tokens for the debt portion;
writing the at least one debt token to a wallet for the debt issuer that is tracked on a distributed ledger;
generating at least one cash token for the cash portion;
writing the at least one cash token to a wallet for the investor that is tracked on a distributed ledger;
settling the transaction by transferring and destroying the at least one cash token from the wallet for the investor, transferring the at least one debt token from the wallet for the debt issuer to the wallet for the investor, and depositing a cash amount for the at least one cash token to the wallet for the debt issuer.

12. The method of claim 11, further comprising:
a first smart contract verifying that the debt issuer has lending capacity for the debt portion.

13. The method of claim 11, further comprising:
a second smart contract verifying that the investor has funds for the cash portion

14. The method of claim 11, wherein a third smart contract generates the at least one debt token.

15. The method of claim 11, wherein the debt issuer generates the at least one debt token.

16. The method of claim 11, wherein a fourth smart contract generates the at least one cash token.

17. The method of claim 11, wherein a financial institution generates the at least one cash token.

18. The method of claim 11, wherein a fifth smart contract transfers and destroys the at least one cash token from the wallet for the investor, transfers the at least one debt token from the wallet for the debt issuer to the wallet for the investor, and deposits the cash amount for the at least one cash token to the wallet for the debt issuer.

19. The method of claim 11, wherein the step of writing the settled transaction to the distributed ledger comprises:
updating a cash balance in the wallet for the investor; and
updating a debt balance in the wallet for the debt issuer.

20. The method of claim 11, wherein the transaction comprises a private transaction.
